(19) United States
(12) Patent Application Publication
(10) Pub. No.: US 2012/0066118 A1
(43) Pub. Date: Mar. 15, 2012

(54) Interface Integration Application Connection between Websites and Social Network in Addition with the Social Network Tree Chart System

(76) Inventor: Kelly C. F. DANTAS, White Plains, NY (US)

(21) Appl. No.: 13/231,846

(22) Filed: Sep. 13, 2011

Related U.S. Application Data
(60) Provisional application No. 61/382,387, filed on Sep. 13, 2010.

(51) Int. Cl. G06Q 40/00; G06F 3/048; G06F 17/30

(52) U.S. Cl. 705/39; 707/769; 715/810; 707/E17.014

(57) ABSTRACT

An interface integration system of a website that provides users with the ability to browse other member profiles from social networks before deciding to initiate a dating communication. This system will help break down geographical barriers while enabling users or members to learn more about a prospective candidate before expending time and effort to pursue interaction. The user provides the present invention permission and credentials to interface the website with his/her social network profile. Social network profile data is imported to the user's website profile and is used to create a tree chart diagram for the desired connection type. These tools allow individuals in the website to be checked or to check others for initiation of safe communication.

The current application claims a priority to the U.S. Provisional Patent application Ser. No. 61/382,387 filed on Sep. 13, 2010.

### FIELD OF THE INVENTION

The present invention relates generally to a website. More specifically, the website provides an interface to social networking sites for retrieval of social network information. The present invention is able to display the social networking information between members of the dating website.

### BACKGROUND OF THE INVENTION

Many studies have shown that people are increasingly living alone and would like to find true love, friendship or others with common interests. But often we hear that it's difficult to find that “real” someone to have a relationship, friendship or even a companionship with, those that enjoy the same activities or interests. We frequently hear this complaint from both men and women and know that this relationship crisis is no created by the deficit of available uninterested people in the world, but the lack of social organizations. Today's social organizations do not actually facilitate date meetings, because of complications that the world imposes on modern everyday life, which makes it very difficult to conduct natural encounters. These difficulties in meeting/date people range from lack of time, to long work schedules, to the justification of promoting professional careers over personal life among other reasons.

Far beyond the difficulties in relation are those of time and the factor of personal feelings. Lots of people have a hard time building friendship and relationships. Giving up their search for friendship, partnership, companionship or love, these people begin to live a great loss of own self confidence and self esteem tending to be in a seclusion and depression which makes the problem increase.

On the Internet there is a huge range of opportunities to meet people who are in the same situation as you. There will always be someone to shred with prejudices, fueled by resistance to new technologies, not to mention those that don't possess the knowledge needed to actually use this technology safely and favorable to benefit their interests. If there is a crisis where these people are having difficulty in meeting each other in the present social organization, especially in large cities imposing themselves to a seclusion and individualism, them it is time to retreat and reflect about using the Internet dating websites in a safe way, to increase the chance of getting to know someone who is willing to live the same as you.

There are several reasons for people to prefer meeting others through Dating Websites. It is more efficient and more likely to lead to desirable relationships than other current methods.

These online dating services enable a user to create a profile which can contain information relating to physical as well as personal characteristics. However some profiles may not represent actual daters, but may be what is known as “bait profiles” that have been placed there by the site owners to attract new paying members, spam users, prostitution users, married people seeking affairs, many members misrepresent themselves by telling flattering ‘white lies’. Gross misrepresentation is less likely on these sites than on ‘casual dating’ sites. Casual dating sites are often geared more towards short term (potentially sexual) relationships.

Yearly, more and more of these different styles of online dating are becoming less secure. There is a false degree of safety assumed by women or man looking for love on the internet, exposing them to stalking, fraud and sometimes sexual violence.

Subsequently a research of the existent Dating Internet websites reveals that there is a need for a Cross-Database Search application system that provides an easy to use mechanism by which each date participant can safely know better and evaluate the other participant who might be interested in dating.

The present invention system addresses this need by providing such an automated Social Network Friends profiles interface and Cross-Database Search mechanism. Briefly, after sign in with a Social Network login and password, accepting of an interface connection between the dating website and the personal Social Network, the user/member will be able to evaluates the other participant by exploring his/her Social Network profile. In this way, the dating users/members may be able to find out if the individuals with who they are trading information's with are real or if it is just one more “bait profile”.

In another aspect of the present invention, in the dating website interface system, after the participant authorize other users/members to view his or her Social Network profile, the participant are also able to join an another automated interface Cross-Database Search mechanism tool, called social network friends tree chart application. This enables the participant to verify if there are any connection between his/her Social Network friends and the friends of prospective dates.

In that way, the dating users/members will be able to know with who they are exchanging info, if the prospective dating is not a scam or a bait profile and also if they have any Social Network Friends connection, all while considering these evaluation before deciding whether or not to arrange a date with the reviewed participant.

In yet another aspect of the present invention, the system may be linked to an established Internet dating website with all Social Network Website such as MySpace, Xanga, Orkut, TagWorld, Friendster, Linkedln, Bebo, Plenty of Fish and others, to provide the features described herein. Alternatively, the system may be linked also to blogs (weblogs), any other dating or social networking sites such as business, school, family social networks and others . . . .

In still a further aspect of the present invention, the system may be accessed, via a mobile device, such as a mobile phone. In that way, participants can conveniently contact their dating member while the date is still fresh in their minds.

In yet another aspect of the present invention, a widget is provided as a user-interface.

### BRIEF DESCRIPTION OF THE DRAWINGS

FIG. 1 illustrates the communication and a process that may be performed when a user registers with the dating web server of FIG. 3-FIG. 14 in accordance with the subject innovation.

FIG. 2 illustrates the communication and a process that may be performed when a user accepts the interface between the dating web server and the Social Network web server of FIG. 7-FIG. 9 and FIG. 11 in accordance with the subject innovation.

FIG. 3-5 illustrates an example of screen shots of web page with administrative features of the First Page/Sign Up of the dating website that facilitates enables the user start registration in accordance with an aspect of the innovation.

FIG. 6 illustrates an example of screen shots of web page with administrative features of flow chart of language options that facilitate establishing a world language possibility in accordance with an aspect of the innovation.

FIG. 7 illustrates an example of screen shots of web page with administrative features of graphical user interface for data base collection in accordance with an aspect of the innovation.

FIG. 8 illustrates an example of screen shots of web page with administrative features of chart diagram from a loading communication system in the form of web screen that enables data connection in accordance with an aspect of the innovation.

FIG. 9 illustrates an example of screen shots of web page with administrative features of graphical chart from the profile data collected, interfaced and registration form in accordance with an aspect of the innovation.

FIG. 10 illustrates an example of screen shots of web page with administrative features of graphical chart for inviting individuals to join the system in order to obtain a new premium membership account in accordance with an aspect of the innovation.

FIG. 11 illustrates an example of screen shots of web page with administrative features which may be provided to enable users to search, email, chat, respond to and be notified of another participant who might be interested in dating in accordance with aspects of the innovation.

FIG. 12 illustrates an example of the Cross-Database Search mechanism loading that will enable the website server Cross-Database Search friends between the MEMBER 1 and MEMBER 2, automatically generating a result according to one aspect of the subject innovation.

FIG. 13-14 illustrates an example of the Cross-Database Search mechanism tool that enable the participant MEMBER 1 to check the automatically generated result if has a positive or negative social network friends connection with the MEMBER 2 who might be interested in dating in accordance with aspects of the innovation.

FIG. 15 illustrates an example chart tree diagram cross process of the MEMBER 1 social network friends connection in accordance with aspects of the innovation.

FIG. 16 illustrates an example chart tree diagram cross process of the MEMBER 2 social network friends connection in accordance with aspects of the innovation.

### DETAIL DESCRIPTIONS OF THE INVENTION

All illustrations of the drawings are for the purpose of describing selected versions of the present invention and are not intended to limit the scope of the present invention. The present invention is described with reference to the drawings, wherein like reference numerals are used to refer to like elements throughout. In the following description, for the purposes of explanation, numerous specific details are set forth in order to provide a thorough understanding of the subject innovation. It may be evident, however, that the present invention can be practiced without these specific details. In other embodiments of the present invention, well-known structures and devices are shown in block diagram form in order to facilitate the description of the invention.

The present invention is for application towards all types of websites for the collection of social networking profiles and friends by an interface integration system. The present invention allows the website users to recognize the individuals that they are communicating with and also verify any friendship connections between the members by a cross-database search mechanism tool. The following description is describes the present invention's application for dating websites. However, the present invention may be applied to any website that involves multiple users that may have interactions with each other.

The terms “subscriber”, “member”, and “user” are used in the following description interchangeably and is not limited to a single person. These terms may be seen as any entity, company, actual person, legal team, groups, or other entities that may use the dating website. The dating website service may store such profile information and friends list information about the social network member. The dating website may make such social network information available to the subscribed members.

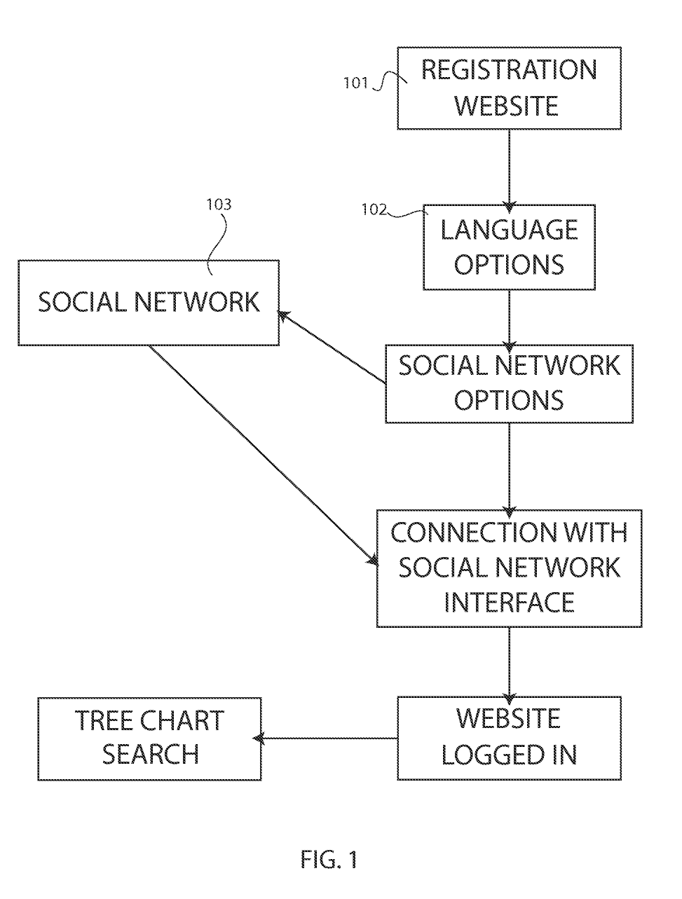

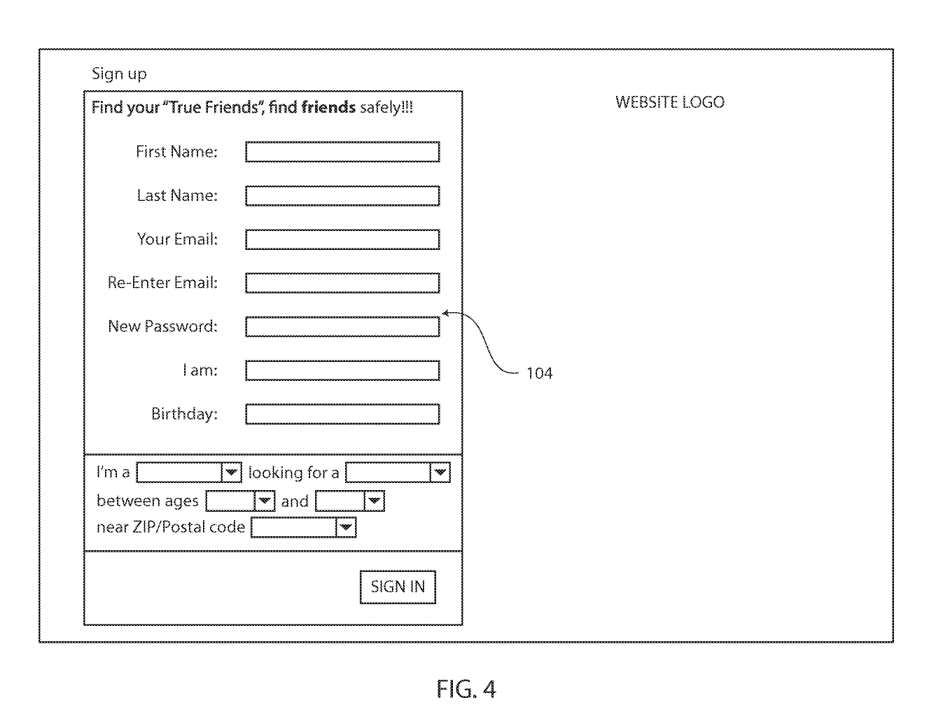

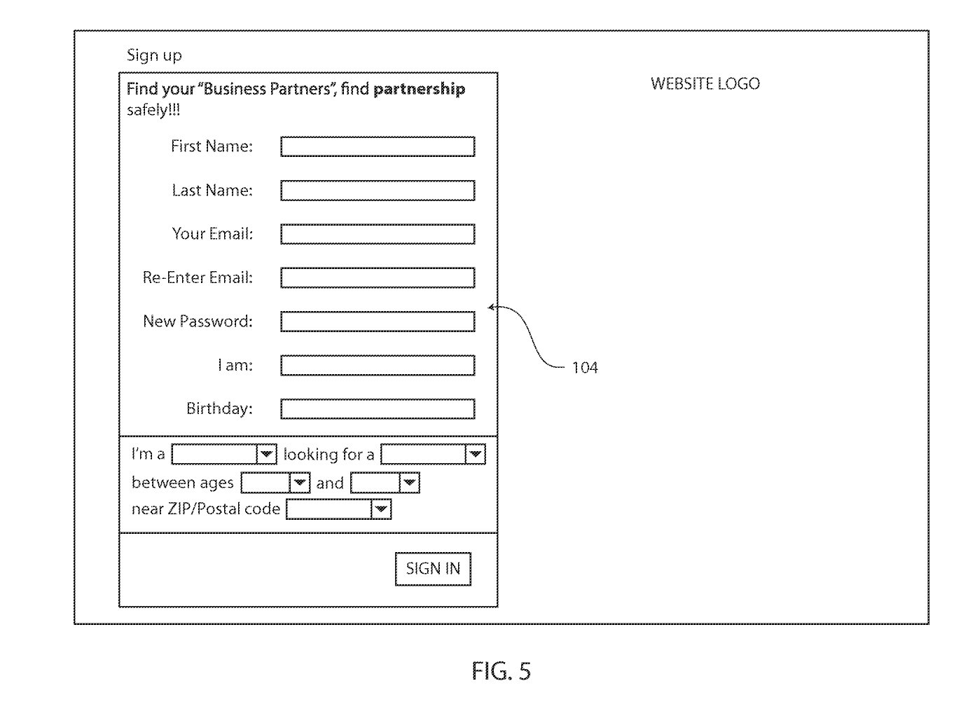

In reference to FIG. 1-16, to initiate the process of the present invention, the user is prompted for member profile data 104 to begin a registration process to the dating website. However, prior to the collection of the member profile data 104, a language menu is displayed prompting the user for selection of a language. As a result, the user is able to utilize the present invention in the language that is most convenient. The member profile data 104 is needed for the purpose of creating a personalized member profile 107 for the user. The member profile data 104 includes personal data information including a first name, middle name, last name, email address, birthday, gender, marital status, number of children wanted, height, hair color, body type ethnicity, smoking habits, drinking habits, education, interests, personal description, location, religion, weight, eye color, physical appearance, drug habits, income, profession, and other personal information depending on the dating website. Once the user has provided their personal information, a menu of social networks 105 are displayed for selection. The menu prompts the user to select a social network of preference. Once the user has selected their social network preference, they are prompted for their social network credentials. The present invention will then temporarily store the social networking credentials 106 to the member profile 107 on the website server. The present invention generates a member profile 107 for the user using the member profile data 104 and accesses the social networking server of the social network selected by the user. The website server is able to interface directly to the social network server and access the user's social network profile using the social network credentials. The user's social network data is then retrieved and stored to the website server. A tree chart is then generated and displayed by the present invention utilizing the social network data. The tree chart shows all of the connections the user has to other people according to his/her social network connections. In other embodiments of the present invention, the tree chart may include connections of different properties or components. Such features can be common interests, common groups, common activities, or any other suitable features that allow one member connect with another.

Once the member profile 107 for the user has been generated, the member profile 107 with the member profile data 104 is displayed. The user is also able to search for other members or subscribers of the dating website. To search for other subscribers, the user is prompted to provide a plurality of search parameters. The plurality of search parameters are specific desired aspects that the user is looking for in other members including data information such as a target age, target gender, target height, target weight, target eye color, target physical appearance, target religion, target location, and any other aspects of the other members. The website will then proceed to search through the website server for a plurality of secondary member profiles accordingly to the plurality of search parameters. When a resulting list of secondary member profiles has been found, the user is able to access and display the plurality of secondary member profiles. Each of the secondary member profiles additionally consist of secondary social network data with a corresponding tree chart. The social network data is information including the member's friends list and other profile data retrieved from the social network server. However, for the user to access and view the secondary social network data of the secondary member profile of interest, they must have a premium membership account. The user is provided with the opportunity to subscribe to a premium membership when they create their accounts. However, the user may also choose to upgrade their accounts at a later time as well. After the dating website collects and confirms the generation of the member profile 107, the user is prompted for an upgrade option of the member profile 107. If confirmed by the user that they wish to upgrade, the user is prompted for payment information. Once the dating website has received the payment information, the user is granted access through the member profile 107 to access the secondary social network data. This access allows the user to view the friends and profile of the secondary member profile 107. An additional feature of the premium membership allows the user to cross database search for matching data between the secondary social network data and the social network data. This allows the user to see if there is he/she already has a connection to the member of the secondary member profile. A comparison diagram is displayed to show the tree chart and the corresponding tree chart. If matching data (mutual friends) is found, the matching data is highlighted and displayed for the user to observe. In the case, no matches are found between the user and the target member of interest, no matching data is displayed.

In reference to FIG. 1-14, the following is a description of a general process of how a user proceeds to use the present invention:

In reference to FIG. 1, a step by step communication and process diagram of the registration process is displayed for the website server 101. The full process starts when the member completes the registration for the dating website. The user is able to choose the language option from a language menu 102, and choose the social networking option. The dating website connects with the social network server 103 to access the social network website. The social network server 103 then accepts the interface connection by the website server 101. This allows the website server 101 it collect social network data and corresponding friend information from the user's social networking profile. The website server utilizes the social network credentials provided by the user to access the social network server. Members are able to subscribe for access to utilize a tree chart friend search tool.

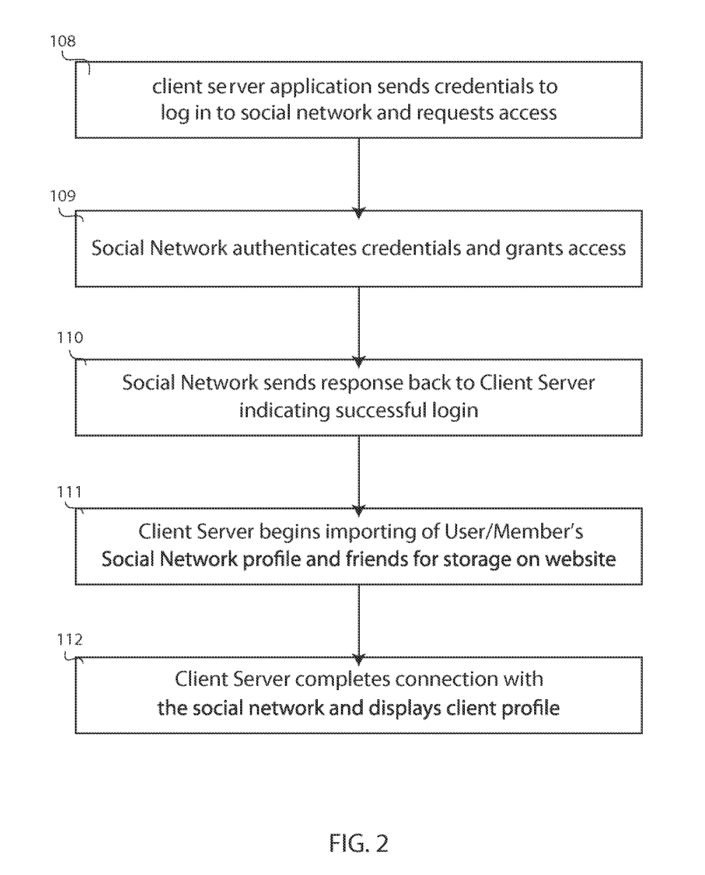

In reference to FIG. 2, an example of the interface login connection process between the website server 101 and the social network server 103 is illustrated. In the login step 108, after the member user has registered with the website server, the social network credentials are sent to the social network server 103 to request access. In step 109, the social network server 103 authenticates and logs into the user's social network profile. In step 110, the social network server 103 sends back a response of successful login and interface connection with the website server 101. In step 111, the website server begins to import the profile and friend list from the social network server 103. The imported data is stored onto the website server 101 for display 112 on the user's member profile 107.

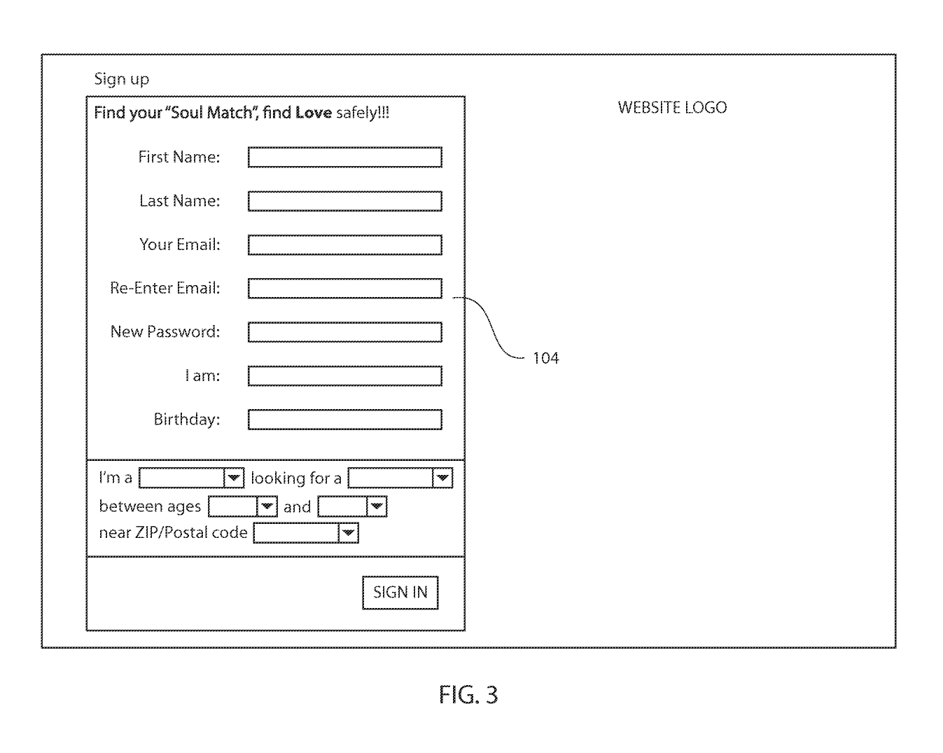

In reference to FIG. 3-5, example screens of the dating website are shown with administrative features of the first/sign-up page in accordance with one embodiment of the present invention. However, in other embodiments of the present invention, the dating website may prompt the user with other information that is needed. This page facilitates and enables the dating website to start the registration process for the user. The present invention can be applied for different types of relationships including relationship dating, match dating, friends dating, business dating, charity dating, sports dating, and other suitable relationships.

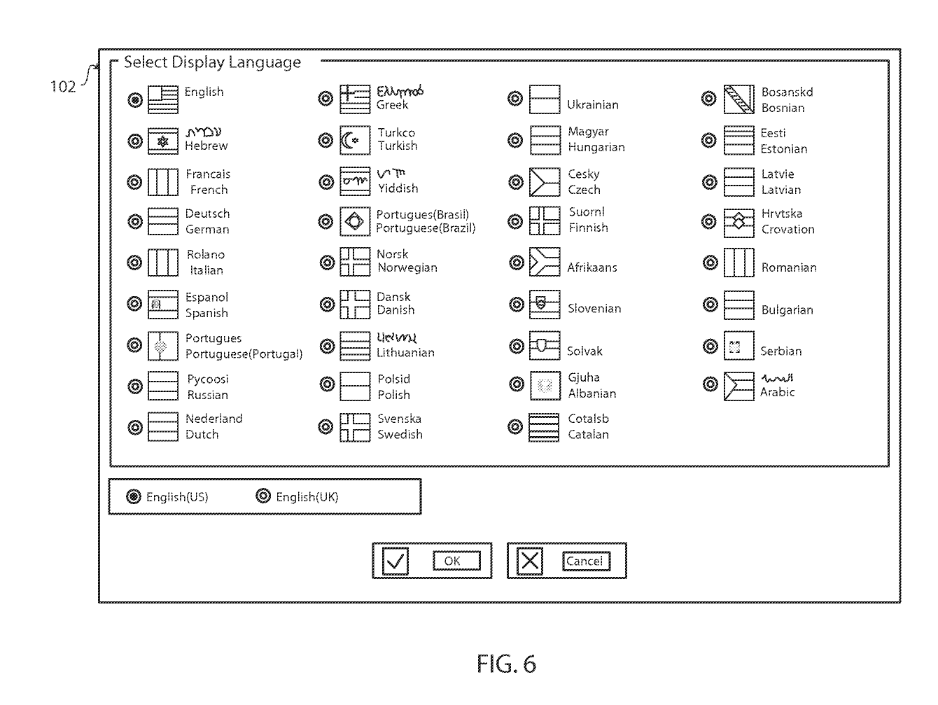

In reference to FIG. 6, the user is displayed a language menu 102 in which they may select their choice of language for navigating through the dating website. Members from all countries around the world are able to use the dating website service with their corresponding language.

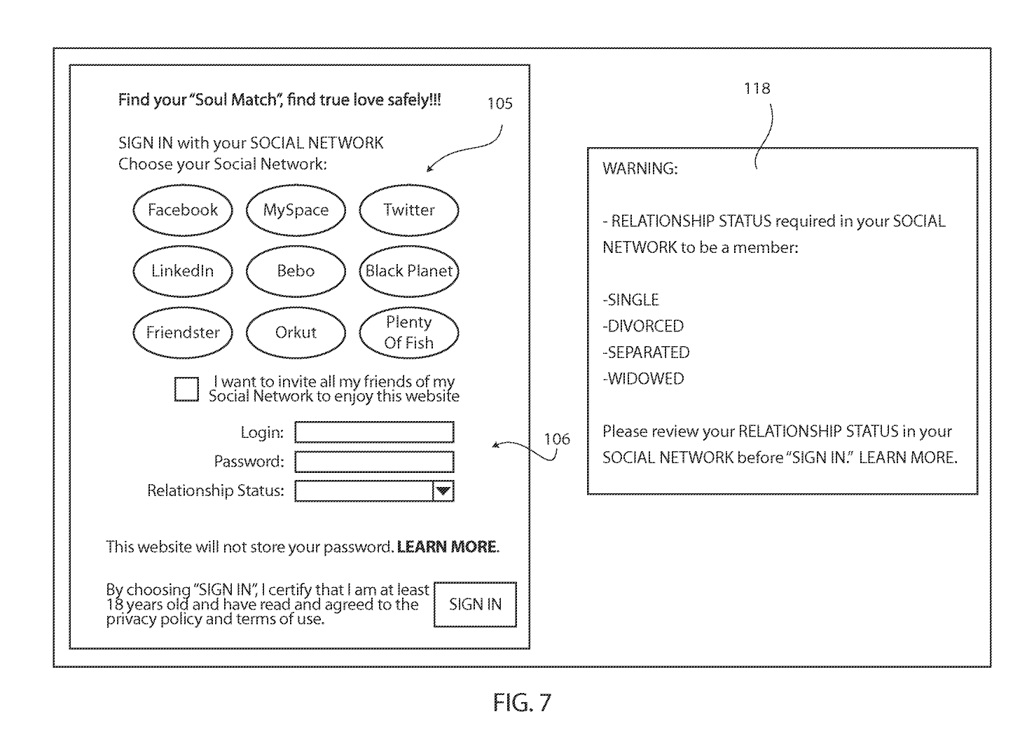

In reference to FIG. 7, after the initial sign-up page, the user is prompted with a graphical user interface for social network data collection. At this step, the user chooses the social network of choice and provides the corresponding social network credentials for their profile. The interface prompts the user specifically for their login, password, and relationship status information. A warning box 118 is shown to new members that relationship status is required in their corresponding social network profile to become a member of the dating website.

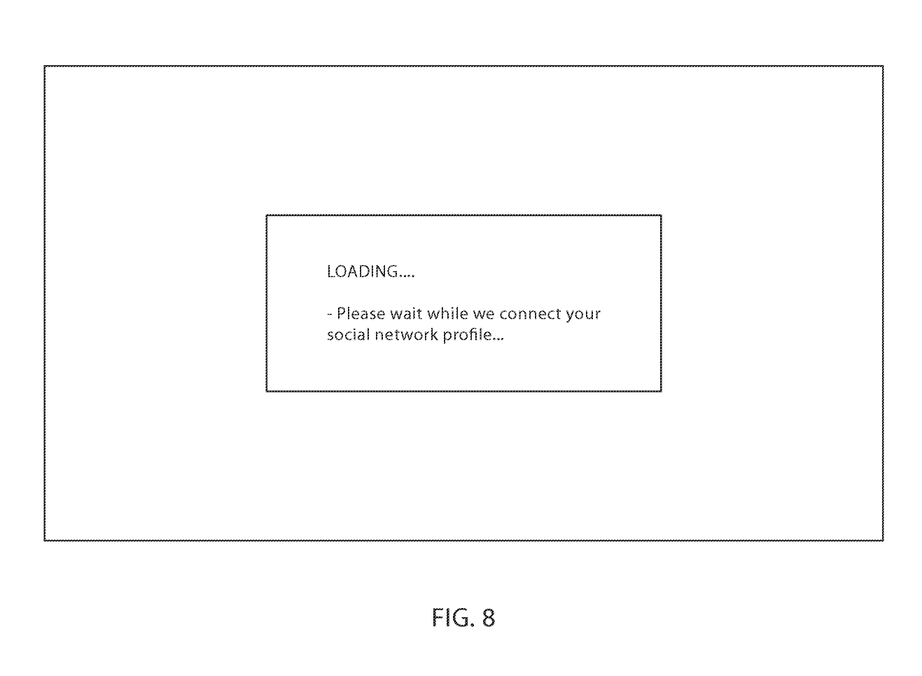

In reference to FIG. 8, the interface of the present invention displays a diagram representing the communication between the website server 101 and the social network server 103 as described in step 109-110 shown in FIG. 2.

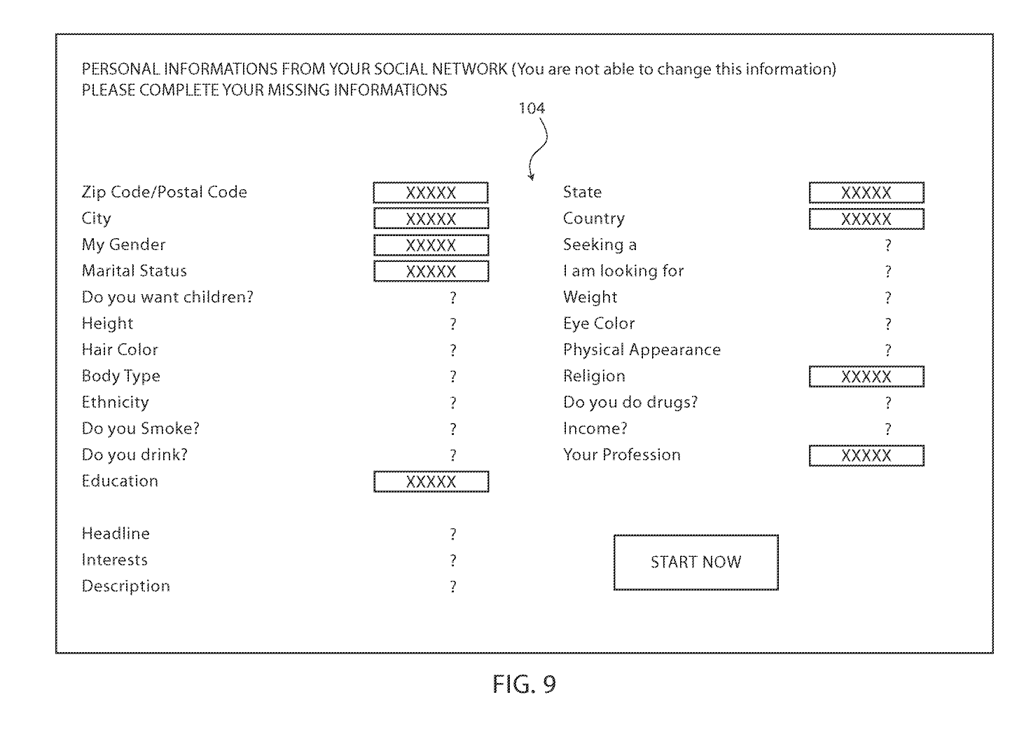

In reference to FIG. 9, the user is displayed a form filled by the importation of the social network data. In some cases, the information provided by the social network data does not complete all of the necessary fields of the form. As a result, the user is prompted to complete the form to provide the remaining member profile data 104. In another embodiment of the present invention, the dating website may be able to individually prompt the user for member profile data 104 in questionnaire format. The questionnaire is a preferable design to obtain personality profile and to verify the identity information of the user. As a result, the user will have a complete profile to start enjoying all the features provided by the dating websites. Additionally, all of the user's dating information is aggregated in an organized fashion to be displayed in the t.

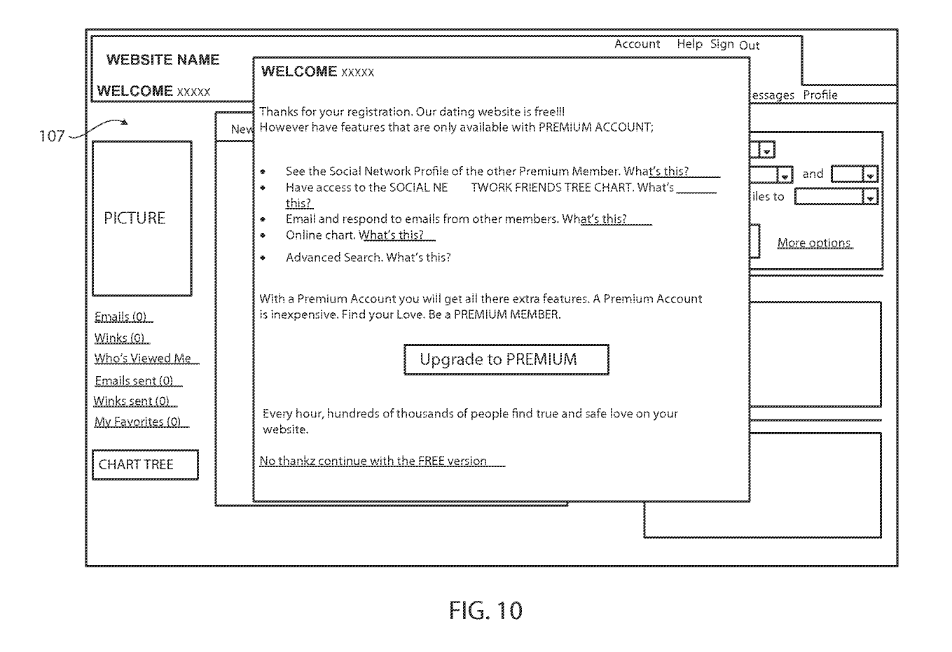

In reference to FIG. 10, after the completion of the member profile 107, the user is prompted with the option to upgrade to a premium membership. The premium membership grants the user to additional features on the dating website including the ability for social network tree chart friends search. This function allows the user (Member 1) to check if there are any connections between his social network friends with friends of another subscriber (Member 2) of the dating website. If the user chooses a premium membership, the member will complete the registration process and provide payment information. However, the user will also be provided the option to skip the premium membership. As a free member, the user will have access to free features of the dating website. The member profile 107 displayed for the free member may appear the same as the member profile 107 of a premium member. However, when the free membership user tries to use premium services such as the social network tree chart friends search, the dating website will prompt the user for the registration with the premium membership. Free membership of the dating website may include seeing basic information about other subscribers. In one embodiment of the present invention, the member will have full access to all the services provided to members of the dating website. Additionally, premium members will be provided access to information about other premium members and free members.

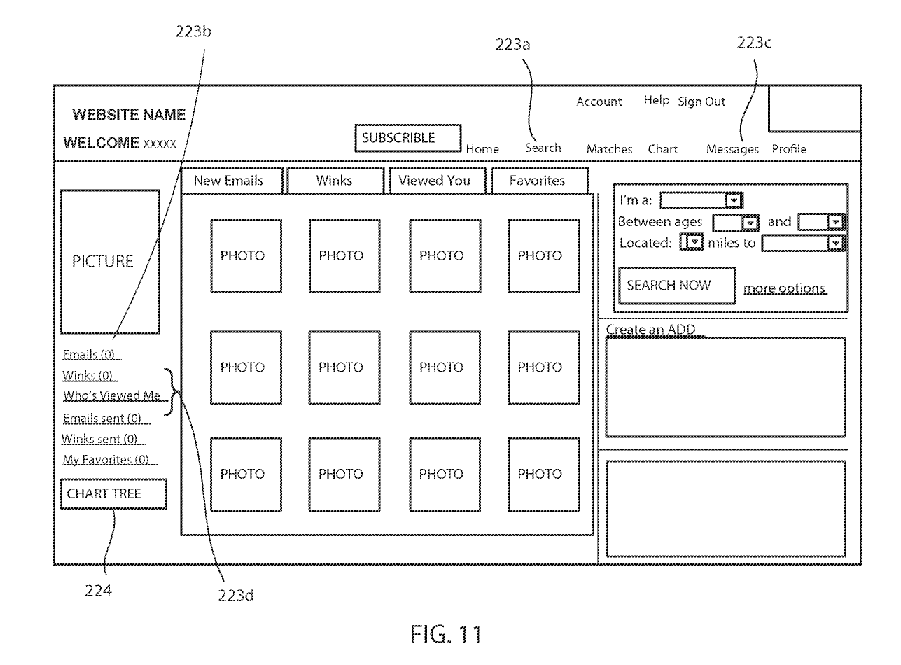

In reference to FIG. 11, the member profile 107 is displayed after the user logs into the dating website. The user will be provided with administrative features such as searching for other members according to a plurality of search parameters 223a, emailing abilities 223b, chatting 223c, responding to and being notified of another participant who may be interested in dating 223d and other features. The member profile 107 displays the personal information of the user provided by the social network server and website server interface connection. The users with the premium membership will have access to the social network tree chart friends search icon 224 on the member profile 107.

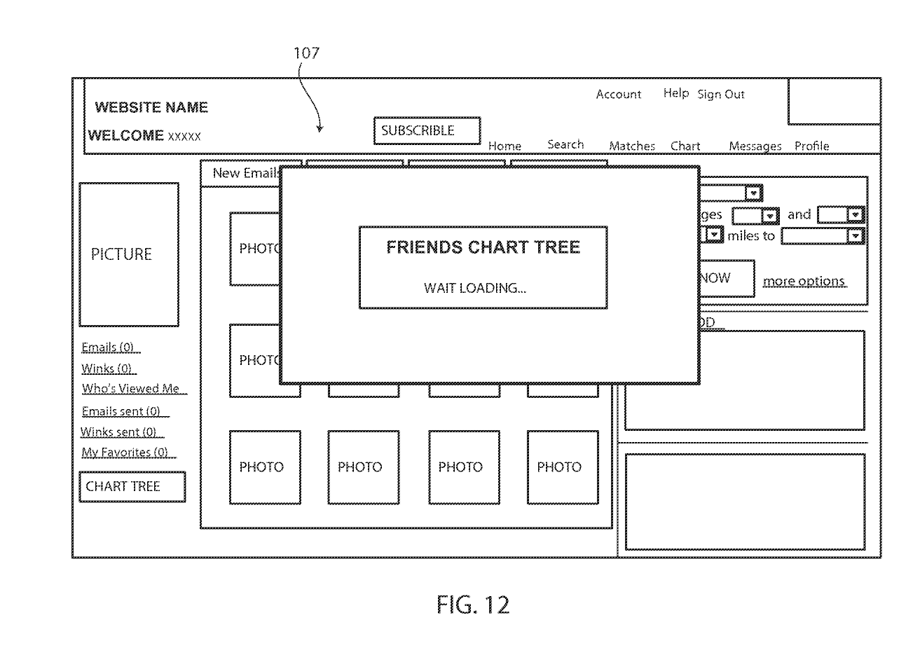

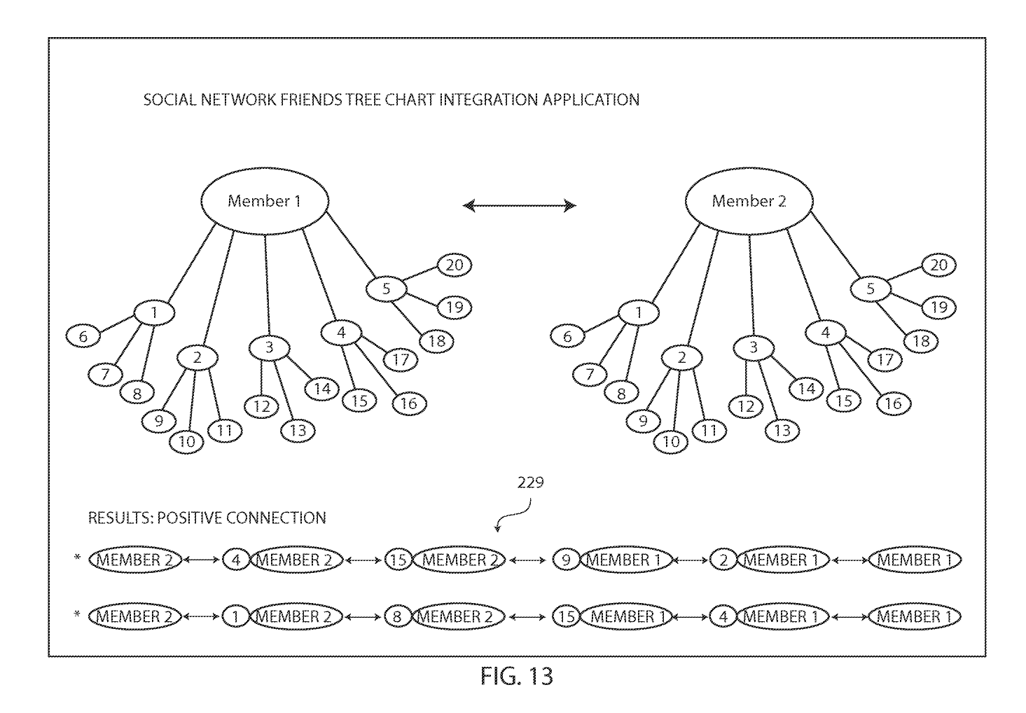

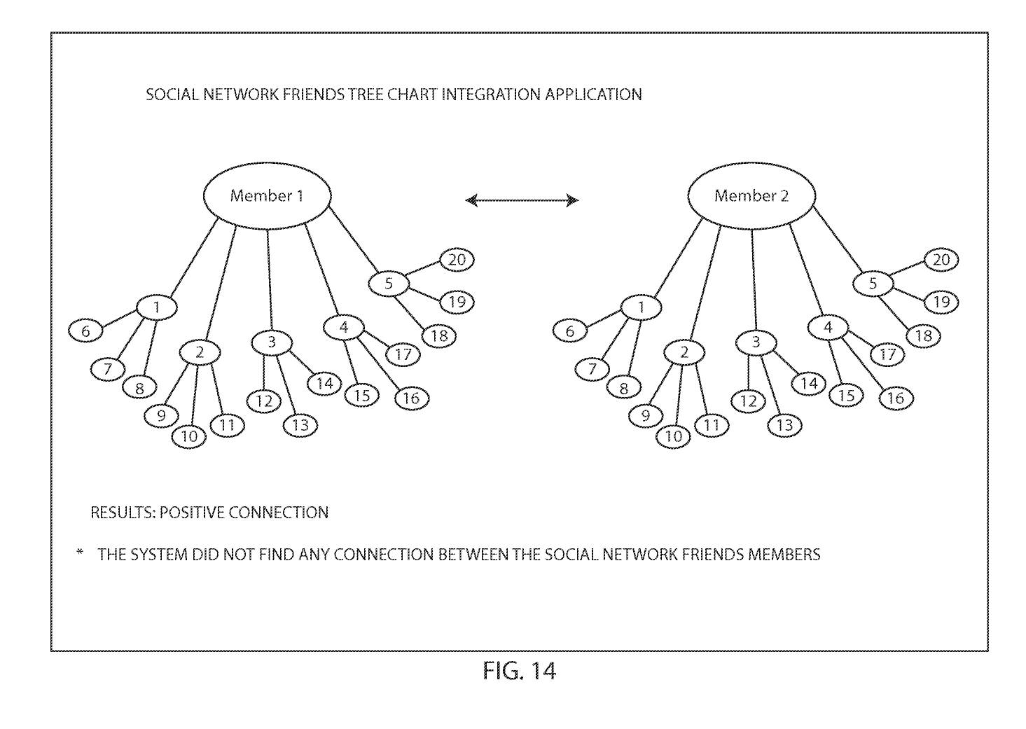

In reference to FIG. 12, the user initiates the social network tree chart friends search. The social network tree chart friends search allows the user to enable the website server 101 to perform a cross-database search for between social network friends of a first member and a second member. In reference to FIG. 13, if the cross-database search mechanism tool results with common connections 229, the results are displayed for the user to view. The user is able to see mutual friendship connections with the member of interest. In reference to FIG. 14, if the cross-database search mechanism tool results in negative results, the user will be shown that there is not connection with the member of interest.

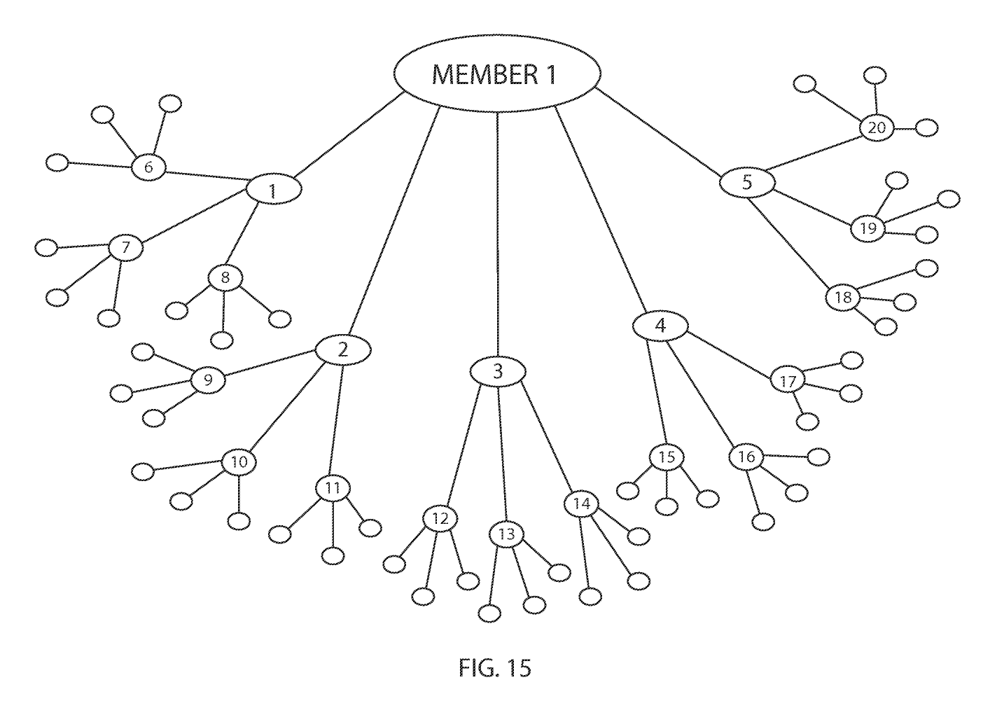

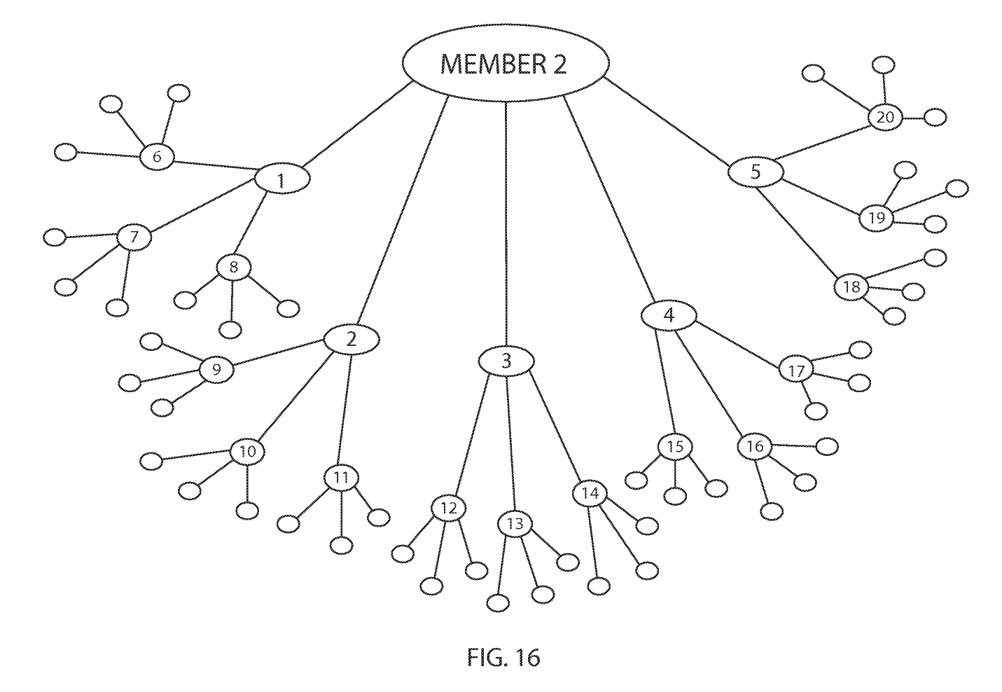

In reference to FIG. 15 and FIG. 16, the user is able to individually view his/her own social networking friend tree generated based on the social network data. The user is able to also view the social networking friend tree of the member of interest. The present invention makes use of the social networking friend tree of the user and the user's member of interest to search for matching data (common friends).

In other embodiments of the present invention, the interface integration of social networks may be applied to any types of website that involves interaction between multiple members. The member profile data can include any informational data suitable to the type of website. For example, instead of a dating website, the present invention can be applied to car sales or car exchange websites. The tree charts can be used to show the legitimacy of a car sales posting and show the connection that a selling party has with other members of the website.

Although the invention has been explained in relation to its preferred embodiment, it is to be understood that many other possible modifications and variations can be made without departing from the spirit and scope of the invention as hereinafter claimed.

What is claimed is:

1. A method of integrating an application connection between a dating website and social network with social networking friend tree by executing computer-executable instruction stored on a non-transitory computer readable medium, the method comprises the steps of:
providing a website server;
providing a social network server;
prompting for member profile data;
displaying a social network selection menu;
prompting for social network selection;
prompting for social network credentials;
storing of the social network credentials and the member profile data to the website server;
generating a member profile using the member profile data;
accessing the social network server by the website server using the social network credentials for retrieving social network data;
generating and displaying a tree chart utilizing the social network data;
prompting for a plurality of search parameters; and
searching the website server for a plurality of secondary member profiles using the plurality of search parameters, wherein each of the secondary member profiles consists of secondary social network data with a corresponding tree chart.

2. The method of integrating an application connection between a dating website and social network with social networking tree chart by executing computer-executable instruction stored on a non-transitory computer readable medium as claimed in claim 1 comprises,
displaying of a language menu; and
prompting for selection of a language from the menu.

3. The method of integrating an application connection between a dating website and social network with social networking tree chart by executing computer-executable instruction stored on a non-transitory computer readable medium as claimed in claim 1 comprises,
displaying of a confirmation following the generation of a member profile;
prompting for upgrade option for the member profile;
prompting of payment information, wherein receiving of payment information grants the member profile access to the secondary social network data;
searching for matching data between the secondary social network data and the social network data;
displaying a comparison diagram showing the tree chart and the corresponding tree chart; and
displaying of the matching data, wherein if there are no matches, no matching data is displayed.

4. The method of integrating an application connection between a dating website and social network with social networking tree chart by executing computer-executable instruction stored on a non-transitory computer readable medium as claimed in claim 1 comprises,
wherein the member profile data is data information including first name, middle name, last name, email address, birthday, gender, marital status, number of children wanted, height, hair color, body type, ethnicity, smoking habits, drinking habits, educations, interests, description, location, religion, weight, eye color, physical appearance, drug habits, income, and profession;
wherein the plurality of search parameters is data information of target age, target gender, target height, target weight, target eye color, target physical appearance, target religion and target location;
displaying of the member profile showing the member profile data; and
displaying of the plurality of secondary member profiles.

5. The method of integrating an application connection between a dating website and social network with social networking tree chart by executing computer-executable instruction stored on a non-transitory computer readable medium as claimed in claim 1 comprises,
wherein the social network data is information including friends list, and other profile data.

6. A method of integrating an application connection between a dating website and social network with social networking friend tree by executing computer-executable instruction stored on a non-transitory computer readable medium, the method comprises the steps of:
providing a website server;
providing a social network server;
prompting for member profile data;
displaying a social network selection menu;
prompting for social network selection;
prompting for social network credentials;
storing of the social network credentials and the member profile data to the website server;
generating a member profile using the member profile data;
accessing the social network server by the website server using the social network credentials for retrieving social network data, wherein the social network data is information including friends list, and other profile data;
generating and displaying a tree chart utilizing the social network data;
prompting for a plurality of search parameters;
searching the website server for a plurality of secondary member profiles using the plurality of search parameters, wherein each of the secondary member profiles consists of secondary social network data with a corresponding tree chart;
displaying of the member profile showing the member profile data; and
displaying of the plurality of secondary member profiles.

7. The method of integrating an application connection between a dating website and social network with social networking tree chart by executing computer-executable instruction stored on a non-transitory computer readable medium as claimed in claim 6 comprises,
displaying of a language menu; and
prompting for selection of a language from the menu.

8. The method of integrating an application connection between a dating website and social network with social networking tree chart by executing computer-executable instruction stored on a non-transitory computer readable medium as claimed in claim 6 comprises,
displaying of a confirmation following the generation of a member profile;
prompting for upgrade option for the member profile;
prompting of payment information, wherein receiving of payment information grants the member profile access to the secondary social network data;
searching for matching data between the secondary social network data and the social network data;
displaying a comparison diagram showing the tree chart and the corresponding tree chart; and
displaying of the matching data, wherein if there are no matches, no matching data is displayed.

9. The method of integrating an application connection between a dating website and social network with social networking tree chart by executing computer-executable instruction stored on a non-transitory computer readable medium as claimed in claim 6 comprises,
wherein the member profile data is data information including first name, middle name, last name, email address, birthday, gender, marital status, number of children wanted, height, hair color, body type, ethnicity, smoking habits, drinking habits, educations, interests, description, location, religion, weight, eye color, physical appearance, drug habits, income, and profession; and
wherein the plurality of search parameters is data information of target age, target gender, target height, target weight, target eye color, target physical appearance, target religion and target location.

10. A method of integrating an application connection between a dating website and social network with social networking friend tree by executing computer-executable instruction stored on a non-transitory computer readable medium, the method comprises the steps of:
providing a website server;
providing a social network server;
displaying of a language menu;
prompting for selection of a language from the menu;
prompting for member profile data;
displaying a social network selection menu;
prompting for social network selection;
prompting for social network credentials;
storing of the social network credentials and the member profile data to the website server;
generating a member profile using the member profile data;
accessing the social network server by the website server using the social network credentials for retrieving social network data, wherein the social network data is information including friends list, and other profile data;
generating and displaying a tree chart utilizing the social network data;
prompting for a plurality of search parameters;
searching the website server for a plurality of secondary member profiles using the plurality of search parameters, wherein each of the secondary member profiles consists of secondary social network data with a corresponding tree chart;
displaying of the member profile showing the member profile data;
displaying of the plurality of secondary member profiles;
displaying of a confirmation following the generation of a member profile;
prompting for upgrade option for the member profile;
prompting of payment information, wherein receiving of payment information grants the member profile access to the secondary social network data;
searching for matching data between the secondary social network data and the social network data;
displaying a comparison diagram showing the tree chart and the corresponding tree chart; and
displaying of the matching data, wherein if there are no matches, no matching data is displayed.

11. The method of integrating an application connection between a dating website and social network with social networking tree chart by executing computer-executable instruction stored on a non-transitory computer readable medium as claimed in claim 10 comprises,
wherein the member profile data is data information including first name, middle name, last name, email address, birthday, gender, marital status, number of children wanted, height, hair color, body type, ethnicity, smoking habits, drinking habits, educations, interests, description, location, religion, weight, eye color, physical appearance, drug habits, income, and profession; and
wherein the plurality of search parameters is data information of target age, target gender, target height, target weight, target eye color, target physical appearance, target religion and target location.
